(19) United States
(12) Patent Application Publication
(10) Pub. No.: US 2018/0321944 A1
(43) Pub. Date: Nov. 8, 2018

(54) DATA RANKING APPARATUS AND METHOD IMPLEMENTED BY HARDWARE, AND DATA PROCESSING CHIP

(71) Applicant: Institute of Computing Technology, Chinese Academy of Sciences, Beijing (CN)

(72) Inventors: Daofu LIU, Beijing (CN); Shengyuan ZHOU, Beijing (CN); Yunji CHEN, Beijing (CN)

(21) Appl. No.: 15/773,970

(22) PCT Filed: Jun. 17, 2016
(86) PCT No.: PCT/CN2016/086096

§ 371 Date: May 4, 2018

(30) Foreign Application Priority Data
Nov. 25, 2015 (CN) 201510828602.0

(51) Int. Cl. G06F 9/30

(52) U.S. Cl. CPC G06F 9/30105; G06F 9/30021; G06F 9/3012

(57) ABSTRACT

The present disclosure relates to a data ranking apparatus that comprises: a register group for storing K pieces of temporarily ranked maximum or minimum data in a data ranking process, the register group comprises a plurality of registers connected in parallel, and two adjacent registers unidirectionally transmit data from a low level to a high level; a comparator group, which comprises a plurality of comparators connected to the registers on a one-to-one basis, compares the size relationship among a plurality of pieces of input data, and outputs the data of larger or smaller value to the corresponding registers; and a control circuit generating a plurality of flag bits applying to the registers, wherein the flag bits are used to judge whether the registers receive data transmitted from corresponding comparators or lower-level registers, and judge whether the registers transmit data to high level registers.

### TECHNICAL FIELD

The present disclosure belongs to the field of computer electronics, and relates to a new type hardware ranking apparatus. More specifically, the present disclosure relates to a data ranking apparatus and a method implemented by hardware, and a data processing chip comprising the data ranking apparatus, which can complete partial ranking work of continuous data stream in parallelism.

### BACKGROUND ART

Ranking operation is a common data processing way, and is widely applied to various programs of the computer. The ranking apparatus is an indispensable part in design of an accelerator. Effective ranking way can optimize using conditions of other algorithm, such as, searching and merging algorithms, and also can accelerate overall acceleration effect of the entire accelerator. In the prior art, software ranking technique have been developed to be perfect and systematic, include insertion ranking, Shell ranking, bubble ranking, selection ranking, merge ranking, quick ranking, heap ranking, and the like, and have achieved a broad application prospect.

However, as for the design of the accelerator, it is obviously not a good idea to directly invocate algorithms on a software level. On one hand, it has to invocate processor resources, and when the processor resources are not available, this type of algorithms cannot be carried out; on the other hand, when using the processor resources, this type of algorithms will occupy large power consumption, while having low computational efficiency. If considering to directly transplant these algorithms from C language to hardware description language, the integrated circuit is poor in timing, while also cannot satisfy application needs. Thus, we have no choice but to consider hardware ranking apparatus, which is simple and effective.

At current stage, in order to accelerate hardware specified ranking operation, industrial and academic circles have raised up various ranking circuits. The most common are ranking algorithms applied to the network, including package ranking in a TCP protocol, which calculate node communication costs to solve knapsack problem so as to construct a high quality heuristic solution of hardware-software partitioning problem, and utilize statistical information and WF²C+ algorithms to realize quick and complete ranking. These algorithms may solve some specific problems in the network field, and can achieve better effect. However, if considering to apply them to the accelerator, on one hand, the apparatus is huge, and occupies large power consumption and area; on the other hand, the functions are specialized, and are not completely identical with the desired functions of the accelerator.

Therefore, with respect to the accelerator we need, we have to design a ranking apparatus, which efficiently completes function of quick partial ranking in large data volume. It is required to satisfy low power consumption, small occupy area, and high ranking efficiency, while the apparatus is simple in structure, and must be applied to the accelerator.

The patent document 1 (publication No.: CN1987771) discloses a hardware circuit for realizing data sequencing and a method, which is used to find out n pieces of maximum or minimum data from in pieces of data, while realizing sequencing of the n pieces maximum or minimum values by size. Each of clocks of the circuit can process one data, and if several sets of sequencing circuits are used to work in parallelism, sequencing time can be greatly decreased, so the circuit is strong in real-time processing, and can satisfy occasions having a high requirement for processing time. However, the invention only ranks data in a single linked list of the software data structure, and when data ranked in the linked list are accessed, a query pointer is required, so the hardware circuit must include (n+1) selectors, extremum pointer register, and decoder, etc. The circuit is complicated, has a large area and power consumption, and after comparing the size of data by comparators, cannot timely update the registers.

### THE PRESENT DISCLOSURE

An object of the present disclosure is to solve at least above problems and deficiencies, and provide a low power consumption, small area, simply structure, and high efficiency data ranking apparatus and a method applicable to an accelerator and implemented by hardware, and a data processing chip comprising the data ranking apparatus using the below technical solution.

As regards to a data ranking apparatus implemented by hardware, comprising:

a register group for saving K pieces of temporarily ranked maximum or minimum data in a data ranking process, wherein K is a positive integer, the register group comprising a plurality of registers connected in parallel, and two adjacent registers unidirectionally transmit data from a low level to a high level;

a comparator group, which comprises a plurality of comparators connected to the registers on a one-to-one basis, compares the size relationship among a plurality of pieces of input data, and outputs the data of larger or smaller value to the corresponding registers; and

a control circuit generating a plurality of flag bits applying to the registers, respectively, the flag bits for judging whether the registers receive data transmitted from the corresponding comparators or lower-level registers, and judging whether the registers transmit data to higher-level registers.

As regards to the data ranking apparatus implemented by hardware of the present disclosure,

each of the registers stores one data, the data sequentially stored in an order from large to small, or from small to large.

As regards to the data ranking apparatus implemented by hardware of the present disclosure,

each of the comparators includes at least two input ports and one output port, and the comparators compare data input from the input ports, and select the maximum values or the minimum values according to a program instruction to output from the output ports.

As regards to the data ranking apparatus implemented by hardware of the present disclosure,

The data in the registers are used as an input data input into the corresponding comparators, and the output ports of the comparators are reversely connected to the corresponding registers to transmit output data to the registers.

As regards to the data ranking apparatus implemented by hardware of the present disclosure,

the control circuit controls to input newly input data in parallelism to each of the comparators as another input data of the comparators.

As regards to the data ranking apparatus implemented by hardware of the present disclosure,

the flag bits at least include one comparison flag bit and one transmission flag bit, the comparison flag bit being for flagging whether comparison results output from the comparators are the same as data stored by the corresponding registers, and the transmission flag bit being for judging whether data are transmitted from the lower-level registers to the registers.

In addition, the present disclosure further provides a method of ranking data using the data ranking apparatus implemented by hardware, comprising:

an initializing step, in which a register group is cleared, and flag bits of a control circuit are set to be 0;

a comparing step, in which data are input into each of comparators of a comparator group, the comparators compare input data in parallelism, and output the data of larger or smaller value to the corresponding registers;

a registering step, in which the register group stores K pieces of temporarily ranked maximum or minimum data in a data ranking process, wherein K is a positive integer; and

a controlling step, in which the control circuit modifies the flag bits according to data transmission and comparison conditions, judge whether the registers receive data transmitted from the corresponding comparators or lower-level registers, and judge whether the registers transmit data to higher-level registers according to the flag bits.

As regards to the method of ranking data of the present disclosure,

in the controlling step, if an output value of one comparator is the same as the currently stored value of the corresponding register, the comparison flag bit is remained to be 0, otherwise, the comparison flag bit is set to be 1.

As regards to the method of ranking data of the present disclosure,

in the controlling step, when a lower-level register connected to a register transmits data to the register, the transmission flag bit is 1, otherwise, the transmission flag bit is remained to be 0.

As regards to the method of ranking data of the present disclosure,

in the controlling step, as for one register, except the lowest level register and the highest level register, when a comparison result returned from the corresponding comparison is received, a comparison flag bit and a transmission flag bit returned from the control circuit are also received, and if the comparison flag bit is 0, i.e., the data currently stored in the register is the same as the comparison result, no operation is performed; if the comparison flag bit is 1, the data currently stored in the register is greater or less than the newly transmitted data, and the transmission flag bit is further judged, and if the transmission flag bit is 1, i.e., no data is transmitted into the register, the data currently stored in the register is transmitted to the higher-level register, data transmitted from the lower-level register is received, the transmission flag bit is returned to 0, the transmission flag bit for the higher-level register is set to be 0, and data returned from the comparison is stored.

In addition, the present disclosure further provides a data processing chip comprising any of the data ranking apparatus implemented by hardware of the present disclosure,

### BRIEF DESCRIPTION OF THE DRAWINGS

FIG. 1 illustrates a block diagram of a data ranking apparatus comprising a register group, a comparator group and a control circuit according to the present disclosure.

FIG. 2 is a flow chart of a data ranking method according to the present disclosure.

FIG. 3 is a flow chart that illustrates, as one example of the present disclosure, partial ranking of continuous data stream from small to large, and selection of K pieces of minimum values.

FIG. 4 illustrates a data processing chip according to the embodiment of the present disclosure.

### PREFERABLE EMBODIMENTS

As stated above, we need to design a data ranking apparatus with hard war, which has a low power consumption, small area, simply structure, and high efficiency and can be applied to an accelerator. By observing data types and data ranges to be ranked in several application fields (machine learning, etc.), as for a specific algorithm in a specific field (such as, knn algorithm in the machine learning), the inventor finds out that it often has to select the first K pieces of maximum/minimum values from mass data, without ranking other data, wherein K is often small, i.e., it only needs to complete few partial ranking in the mass data. Thus, the inventor provides a ranking apparatus and a method implemented by hardware having the above technical solution, which are especially adapted to real-time partial ranking operation of continuous data stream. The ranking apparatus can only rank a size order of the first K pieces of values to quickly complete the ranking according to the user's requirement for the desired data range. The apparatus is simple in structure, and as compared to common full ranking hardware, it has advantages of high efficiency, low power consumption and small area.

The ranking apparatus implemented by the hardware in the present disclosure comprises a register group, which is consisted of a plurality of registers, and stores K pieces of temporarily ranked maximum or minimum data; a comparator group, which is consisted of a plurality of comparators, and compare the size relationship of two or more data transmitted to the comparators; and a control circuit for controlling data input and data output in the comparator group and the register group, wherein the control circuit generates a plurality of flag bits applying to each of the registers, respectively. The connection relation between the control circuit and the register and comparator groups is that values of the registers and the newly input data are used as input of the comparators, and result signals of the comparators control whether the registers update or shift through a controller (according to the comparison flag bits and transmission flag bits).

Moreover, two adjacent registers may unidirectionally transmit data from low to high, i.e., a lower-level register may transmit data to a higher-level register. When the lower-level register transmits data to the higher-level register, a transmission flag bit for the higher-level register is to be modified to flag the transmission of data. When the higher-level register receives and stores the data transmitted from the lower-level register, the transmission flag bit is set to be zero, and the higher-level register goes back to an initial state.

Each of the comparators is connected after the register, and data can be transmitted from the register to the comparator, and another data is newly input data to be compared. Output of each of the comparators is returned to the register, and a comparison flag bit is modified to flag whether the raw data stored in the register are the same as the data to be compared. After the register processes the data, no matter whether to select to receive and store, or not to receive and store, the comparison flag bit is set to be zero, the register goes back to the initial state, and waits for input of new data and a new round of comparison.

Function of the flag bits for each of the registers is to flag whether the register shall transmit data to a higher-level register, and whether the register shall receive data from a lower-level register. Specifically, the control circuit generates two flag bits for each of the registers, wherein one is a comparison flag bit, and the other is a transmission flag bit. The comparison flag bit is to indicate whether data returned from the comparator are the same as the data input from the corresponding registers, and if they are different, it is set to be 1. The transmission flag bit is used to judge whether data are transmitted from a lower-level register, and if yes, it is set to be 1. These two flag bits are used to control whether the data in the register need to be changed, if the data need to be changed, the data shall be changed to the data from the comparators or the date from the lower-level registers; and judge whether the original data are transmitted to a higher-level register. More specifically, the register group firstly judges the comparison flag bit returned by the control circuit, and if the comparison flag bit is 0, i.e., raw data in the register are the same as the data to be compared, no operation is performed; if the comparison flag bit is 1, it means that the raw data in the register are greater/less than the newly input data, and another transmission flag bit shall be considered; if it is 0, it means that no data is transmitted to the register, the data currently stored in the register are transmitted to the higher-level register, the transmission flag bit for the higher-level register is set to be 0, and then the data returned from the comparator are stored; if the transmission flag bit is 1, it means that the newly input data are greater/less than data in the lower-level register, the data are transmitted to higher-level data, a higher-level transmission flag bit is set to be 1, and then data transmitted from the lower-level register are received to return the transmission flag bit to 0. It is to be noted that all flag bits have to be initialized to 0. After each operation, it also has to be returned to zero timely.

Before ranking the input data, the data ranking apparatus is initialized, and the register group is cleared at initialization. Then, with input of data stream, the register group is gradually filled up. If the required K value is less than a total of registers in the register group, only K pieces of the lowest level registers can be used. When the register group is not filled up with data, the newly input data will be sequentially stored in the register group, i.e., if the register group is empty, they are stored in the lowest level registers; if the newly input data are greater/less than the available data in the register group, they are stored in the higher-level registers of the registers having the available data; otherwise, data greater/less than the new data are sequentially shifted to the higher-level registers, and then the new data are inserted into the register in a middle position.

In order to make the object, the technical solution and advantages of the present disclosure much clearer, the data ranking apparatus and the method implemented by hardware of the present disclosure are further explained in detail below with reference to the drawings.

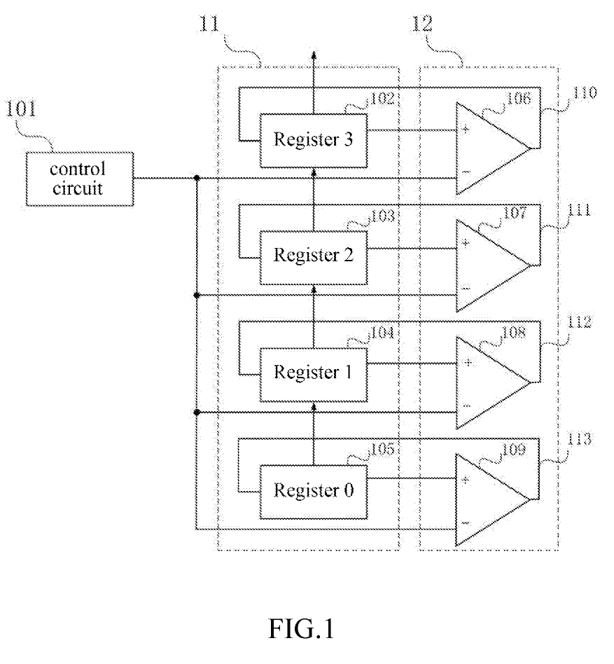

FIG. 1 illustrates a block diagram of a data ranking apparatus, as an example, comprising a register group, a comparator group, and a control circuit. The register group 11 is consisted of a plurality of registers, as shown in FIG. 1, supposing that it is consisted of four registers, which are 102, 103, 104 and 105, respectively. The comparator group 12 is consisted of a plurality of comparators, as shown in FIG. 1, supposing that it is consisted of four comparators, which are 106, 107, 108 and 109, respectively. Two adjacent registers may unidirectionally transmit data from a low level to a high level, each of the registers is connected to a comparator, and may transmit data to the comparator, and an output result of the comparator is returned to the register.

Supposing that we select the first K pieces of smaller values, new data are input from 101 in a control apparatus, and then delivered to each of the comparators as another input of the comparators. Next, the comparator group works simultaneously, completes comparison operations in parallelism, obtains the smaller values as a comparison result to output, and modifies comparison flag bits. Selecting a pair of comparators 108 and the register 104 for example, if an output value of the comparators 108 is the same as the currently stored value of the register 104, comparison flag bits keep unchanged, otherwise, the comparison flag bits are 1. Viewing a transmission flag bit of the register 104, if the transmission flag bit is 0, it means that the register 105 does not transmit data to the register 104, values in the register 104 are transmitted to the register 103 upwardly, a transmission flag bit of the register 103 is modified to 1, and then an output result of the comparators 108 are stored in the register 104. If the transmission flag bit of the register 104 is 1, it means that the register 105 transmits data to the register 104, the values in the register 104 are transmitted to the register 103 upwardly, the transmission flag bit of the register 103 is modified to 1, then data transmitted from the register 105 are stored in the register 104, and the transmission flag bit of the register 104 is returned to zero. Other register and comparator perform similar operations.

As for the lowest level register 105, there is no need to judge the transmission flag bit, i.e., the comparison flag bit is 1, values of the register 105 are transmitted to the register 104 upwardly, then the transmission flag bit of the register 104 is modified, and an output result of the comparator 109 is stored. As for the highest level register 102, there is no need to perform delivering operation upwardly, i.e., if the comparison flag bit is 1, and the transmission flag bit is 0, an output result of the comparator 106 is directly stored; if the comparison flag bit is 1, and the transmission flag bit is 1, data values transmitted from the register 103 are directly stored, and the transmission flag bit is returned to zero.

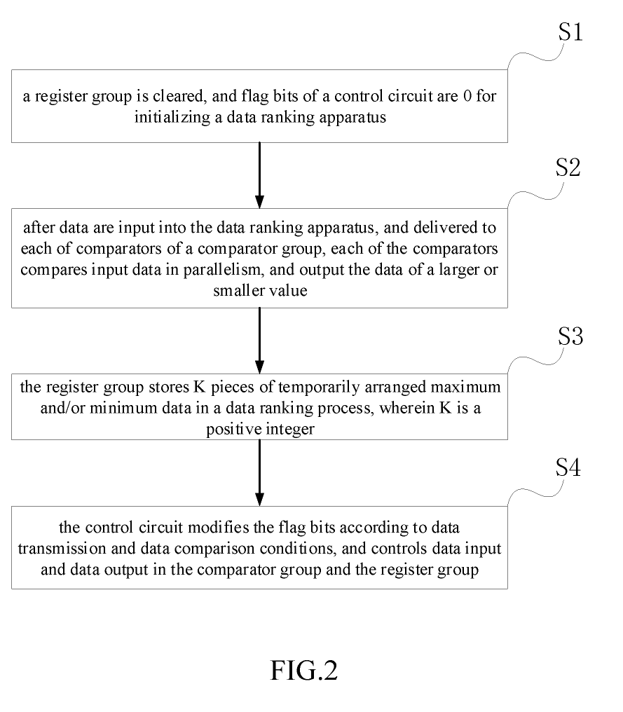

FIG. 2 is a flow chart of a data ranking method of the present disclosure, comprising: an initializing step S1, in which a register group is cleared, and flag bits of a control circuit are 0 for initializing a data ranking apparatus; a comparing step S2, in which after data are input into the data ranking apparatus, and delivered to each of comparators of a comparator group, each of the comparators compares input data in parallelism, and output the data of larger or smaller value; a registering step S3, in which the register group stores K pieces of temporarily arranged maximum and/or minimum data in a data ranking process, wherein K is a positive integer; a controlling step S4, in which the control circuit modifies the flag bits according to data transmission and data comparison conditions, and controls data input and data output in the comparator group and the register group.

In the controlling step S4, if an output value of one comparator is the same as the currently stored value of the corresponding register, the comparison flag bit is remained to be 0, otherwise, the comparison flag bit is set to be 1. When the lower-level register connected to the register transmits data to the register, the transmission flag bit is 1, otherwise, the transmission flag bit is remained to be 0. As for one register, except the lowest level register and the highest level register, when a comparison result returned from the corresponding comparator is received, a comparison flag bit and a transmission flag bit returned from the control circuit are also received, and if the comparison flag bit is 0, i.e., raw data in the register are the same as the comparison result, no operation is performed; if the comparison flag bit is 1, the raw data in the register is greater or less than newly transmitted data, and the transmission flag bit is further judged, if the transmission flag bit is 1, i.e., no data is transmitted to the register, the data currently stored in the register is transmitted to the higher-level register, data transmitted from the lower-level register is received, the transmission flag bit is returned to 0, a transmission flag bit of the higher-level register is set to be 0, and data returned from the comparator is stored.

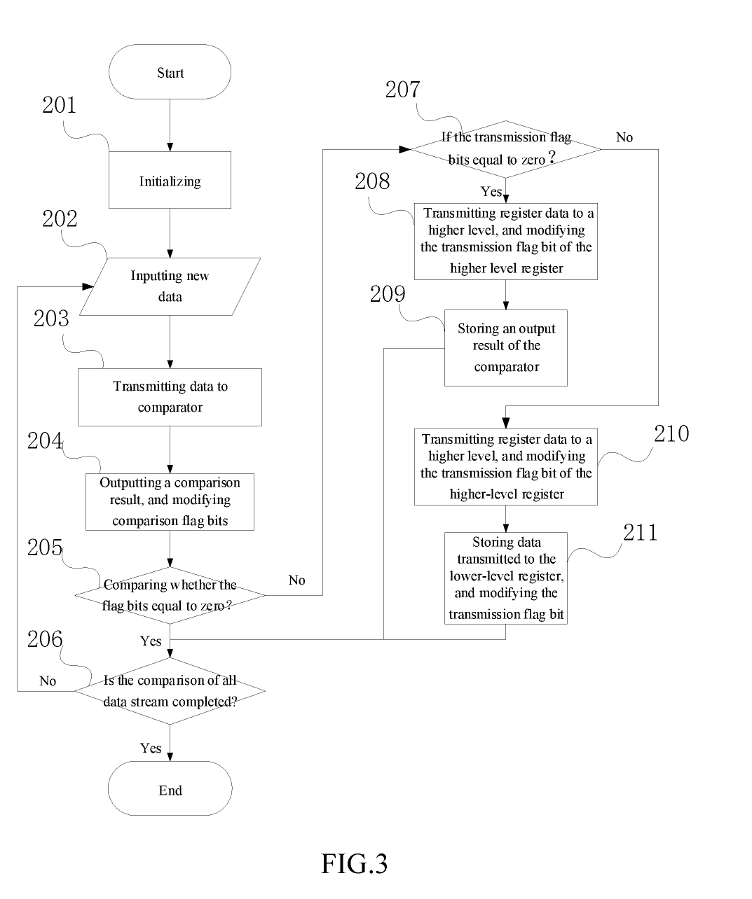

FIG. 3 is a flow chart that illustrates that the ranking apparatus performs partial ranking of continuous data stream in detail according to one example of the present disclosure. For convenience of expression, partial ranking of data stream m₁, m₂, . . . , mₙ (n>k, n is a positive integer) is performed to select four minimum values based on the circuit of FIG. 1. Initialization is performed in step 201, i.e., all registers are cleared, and all transmission flag bits and comparison flag bits are returned to zero. In step 202, the first data m₁ is input from 101 of FIG. 1. Since there is no data at the very beginning, the data are directly stored in the register 105 of FIG. 1. After judging that the transmission of the continuous data stream is not completed in step 206, the step 202 is returned, and the second data m₂ is input from 101 of FIG. 1. Since only the register 105 has data, m₂ is transmitted to the comparator 109 for comparison, if m₁>m₂, an output result of the comparator is m₂, and the comparison flag bit is 1; since the register 105 is the lowest level register, there is no need to compare the transmission flag bit, the data in the original register 105 is transmitted and stored in the register 104, the register 105 receives and stores result data of the comparator 109, and then the comparison flag bit is set to be zero; if m₁<m₂, m₂ is stored in the register 104. When the third data m₃ and the fourth data m₄ are input, the similar operations are performed, and at this time, data have been stored in the four registers. When data m₅ is input at the step 202, step 203 is performed to transmit the data to the four comparators as one input, and the four registers transmit the stored data respectively to the four comparators as another input. Step 204 is performed to make comparison. Each of the comparators selects the data of a smaller value as a comparison result to output, and judges whether the output result is the same as the original value in the register, and if they are different, the comparison flag bit is set to be 1. By judging in step 205, if the comparison flag bit is 0, because there is new data, the step 202 is returned to perform looping execution, otherwise, judging whether the transmission flag bit is 0, if it is 0, the original value in the register is transmitted to the higher-level register, and the transmission flag bit for the higher-level register is set to be 1, then the comparison result transmitted from the comparator is received and stored, and the comparison flag bit is returned to zero. Otherwise, the original value in the register is transmitted to the higher-level register, and the transmission flag bit for the higher-level register is set to be 1, then data transmitted from the lower-level register is received and stored, and the comparison flag bit and the transmission flag bit are set to be 0. Next, because there is new data, the step 202 is returned to perform looping execution. Cycle repeats till all data, i.e., mₙ, is also transmitted and processed, and data stored in the registers 102, 103, 104 and 105 are the four minimum values in the continuous data stream.

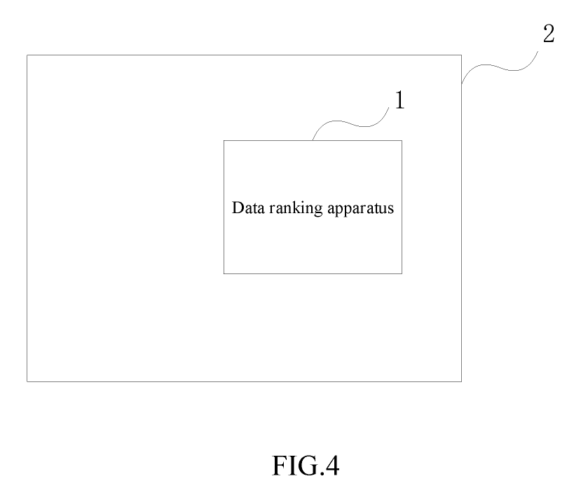

In addition, as shown in FIG. 4, the present disclosure further provides a data processing chip 2 comprising the data ranking apparatus 1 implemented by hardware.

The present disclosure may be applied in many general or special computer system environments or configurations, such as, personal computer, server computer, handheld or portable device, flat type device, multiprocessor system, microprocessor-based system, set-top box, programmable consumer electronic device, network PC, minicomputer, mainframe computer, distributed computing environment including any system or device thereof, and the like.

The present disclosure may be described in general context of the computer executable instruction executed by the computer, such as, a program module. Generally, the program module includes routines, programs, objects, assemblies, data structures, and the like that execute specific task, or achieve specific abstract data type.

Further, the terms “comprise” and “include” not only comprise those factors, but also comprise other factors that are not clearly listed, or further comprise inherent factors of the procedure, method, article or device. Under the circumstance of having no further limitation, the factor defined by the sentence “comprise . . . ” does not exclude additional same factor existed in the procedure, method, article or device comprising the factors.

The present disclosure is described with reference to the flow charts of the method, device (system), and the computer program product, and/or the block diagram. It shall be understood that the combination of the flows and/or the blocks can be achieved by the computer program instructions. These computer program instructions may be provided to the general computer, special computer, embedded processor, or processor of other programmable data processing device to produce a machine, such that an apparatus for achieving the specified function in one or more flows of the flow chart, and/or one or more blocks of the block diagram is produced by the instructions executed by the computer, or processor of other programmable data processing device.

These computer program instructions may also be stored in a readable memory of the computer that can guide the computer, or other programmable data processing device to work in a specific way, such that the instructions stored in the readable memory of the computer produce a manufactured product including a command device which achieves the specified function in one or more flows of the flow chart, and/or one or more blocks of the block diagram.

These computer program instructions may also be loaded to the computer, or other programmable data processing device to execute a series of operation steps on the computer, or other programmable device to produce processing implemented by the computer, such that the instructions executed on the computer, or other programmable device provide steps for achieving the specified function in one or more flows of the flow chart, and/or one or more blocks of the block diagram.

### INDUSTRIAL APPLICABILITY

(1) According to the data ranking apparatus and the method of the present disclosure, K pieces of maximum/minimum values can be quickly found from input mass data, which is adapted to real-time partial ranking operation of continuous data stream.

(2) According to the data ranking apparatus and the method of the present disclosure, input data are ranked by using local comparing and selecting (shifting) way, and whether a new register has to be updated can be determined immediately while making comparison (shifting from last register, or inserting new data).

(3) According to the data ranking apparatus and the method of the present disclosure, the control circuit can be briefer, an area of the circuit is decreased, power consumption of the circuit is reduced, and since the input data are compared and ranked using the shifting way, they are moved from last one, so (n+1) selectors, extremum pointer register, decoder, and the like are not required, and half of the area and power consumption can be stored.

(4) According to the data ranking apparatus and the method of the present disclosure, since the registers are not to store extreme values, but directly store N pieces of final extreme values, efficiency of the data ranking apparatus can be improved.

1. A data ranking apparatus implemented by hardware, comprising:
a register group for saving K pieces of temporarily ranked maximum or minimum data in a data ranking process, wherein K is a positive integer, the register group comprising a plurality of registers connected in parallel, and two adjacent registers unidirectionally transmit data from a low level to a high level;
a comparator group, which comprises a plurality of comparators connected to the registers on a one-to-one basis, compares the size relationship among a plurality of pieces of input data, and outputs the data of larger or smaller value to the corresponding registers; and
a control circuit generating a plurality of flag bits applying to the registers, respectively, the flag bits for judging whether the registers receive data transmitted from the corresponding comparators or lower-level registers, and judging whether the registers transmit data to higher-level registers.

2. The data ranking apparatus implemented by hardware according to claim 1, wherein,
each of the registers stores one data, the data sequentially stored in an order from large to small, or from small to large.

3. The data ranking apparatus implemented by hardware according to claim 1, wherein,
each of the comparators includes at least two input ports and one output port, and the comparators compare data input from the input ports, and select the maximum values or the minimum values according to a program instruction to output from the output ports.

4. The data ranking apparatus implemented by hardware according to claim 1, wherein,
The data in the registers are used as an input data input into the corresponding comparators, and the output ports of the comparators are reversely connected to the corresponding registers to transmit output data to the registers.

5. The data ranking apparatus implemented by hardware according to claim 4, wherein,
the control circuit controls to input newly input data in parallelism to each of the comparators as another input data of the comparators.

6. The data ranking apparatus implemented by hardware according to claim 1, wherein,
the flag bits at least include one comparison flag bit and one transmission flag bit, the comparison flag bit being for flagging whether comparison results output from the comparators are the same as the data stored by the corresponding registers, and the transmission flag bit being for judging whether data are transmitted from the lower-level registers to the registers.

7. A data ranking means by using a data ranking apparatus implemented by hardware, wherein the data ranking apparatus implemented by hardware comprises:
a register group for saving K pieces of temporarily ranked maximum or minimum data in a data ranking process, wherein K is a positive integer, the register group comprising a plurality of registers connected in parallel, and two adjacent registers unidirectionally transmit data from a low level to a high level;
a comparator group, which comprises a plurality of comparators connected to the registers on a one-to-one basis, compares the size relationship among a plurality of pieces of input data, and outputs the data of larger or smaller value to the corresponding registers; and
a control circuit generating a plurality of flag bits applying to the registers, respectively, the flag bits for judging whether the registers receive data transmitted from the corresponding comparators or lower-level registers, and judging whether the registers transmit data to higher-level registers;
the method of ranking data comprising the following steps:
an initializing step, in which a register group is cleared, and flag bits of a control circuit are set to be 0;
a comparing step, in which data are input into each of comparators of a comparator group, the comparators compare input data in parallelism, and output the data of larger or smaller value to the corresponding registers;
a registering step, in which the register group stores K pieces of temporarily ranked maximum or minimum data in a data ranking process, wherein K is a positive integer; and
a controlling step, in which the control circuit modify the flag bits according to data transmission and comparison conditions, judge whether the registers receive data transmitted from the corresponding comparators or lower-level registers, and judge whether the registers transmit data to higher-level registers according to the flag bits.

8. The data ranking means by using the data ranking apparatus implemented by hardware according to claim 7, wherein in the controlling step, if an output value of one comparator is the same as the currently stored value of the corresponding register, the comparison flag bit is remained to be 0, otherwise, the comparison flag bit is set to be 1.

9. The data ranking means by using the data ranking apparatus implemented by hardware according to claim 7, wherein in the controlling step, when a lower-level register connected to a register transmits data to the register, the transmission flag bit is 1, otherwise, the transmission flag bit is remained to be 0.

10. The data ranking means by using the data ranking apparatus implemented by hardware according to claim 7, wherein in the controlling step, as for one register, except the lowest level register and the highest level register, when a comparison result returned from the corresponding comparator is received, a comparison flag bit and a transmission flag bit returned from the control circuit are also received, and if the comparison flag bit is 0, i.e., the data currently stored in the register is the same as the comparison result, no operation is performed; if the comparison flag bit is 1, the data currently stored in the register is greater or less than the newly transmitted data, and the transmission flag bit is further judged, if the transmission flag bit is 1, i.e., no data is transmitted into the register, the data currently stored in the register is transmitted to the higher-level register, data transmitted from the lower-level register is received, the transmission flag bit is returned to 0, a transmission flag bit of the higher-level register is set to be 0, and data returned from the comparator is stored.

11. A data processing chip comprising a data ranking apparatus implemented by hardware, wherein the data ranking apparatus is implemented by hardware comprising:
a register group for saving K pieces of temporarily ranked maximum or minimum data in a data ranking process, wherein K is a positive integer, the register group comprising a plurality of registers connected in parallel, and two adjacent registers unidirectionally transmit data from a low level to a high level;
a comparator group, which comprises a plurality of comparators connected to the registers on a one-to-one basis, compares the size relationship among a plurality of pieces of input data, and outputs the data of larger or smaller value to the corresponding registers; and
a control circuit generating a plurality of flag bits applying to the registers, respectively, the flag bits for judging whether the registers receive data transmitted from the corresponding comparators or lower-level registers, and judging whether the registers transmit data to higher-level registers.

12. The data processing chip comprising the data ranking apparatus implemented by hardware according to claim 11, wherein each of the registers stores one data, the data sequentially stored in an order from large to small, or from small to large.

13. The data processing chip comprising the data ranking apparatus implemented by hardware according to claim 11, wherein each of the comparators includes at least two input ports and one output port, and the comparators compare data input from the input ports, and select the maximum values or the minimum values according to a program instruction to output from the output ports.

14. The data processing chip comprising the data ranking apparatus implemented by hardware according to claim 11, wherein the data in the registers are used as an input data input into the corresponding comparators, and the output ports of the comparators are reversely connected to the corresponding registers to transmit output data to the registers.

15. The data processing chip comprising the data ranking apparatus implemented by hardware according to claim 14, wherein the control circuit controls to input newly input data in parallelism to each of the comparators as another input data of the comparators.

16. The data processing chip comprising the data ranking apparatus implemented by hardware according to claim 11, wherein the flag bits at least include one comparison flag bit and one transmission flag bit, the comparison flag bit being for flagging whether comparison results output from the comparators are the same as the data stored by the corresponding registers, and the transmission flag bit being for judging whether data are transmitted from the lower-level registers to the registers.

17. A ranking data means by using a data processing chip, wherein the data processing chip comprises:
a register group for saving K pieces of temporarily ranked maximum or minimum data in a data ranking process, wherein K is a positive integer, the register group comprising a plurality of registers connected in parallel, and two adjacent registers unidirectionally transmit data from a low level to a high level;
a comparator group, which comprises a plurality of comparators connected to the registers on a one-to-one basis, compares the size relationship among a plurality of pieces of input data, and outputs the data of larger or smaller value to the corresponding registers; and
a control circuit generating a plurality of flag bits applying to the registers, respectively, the flag bits for judging whether the registers receive data transmitted from the corresponding comparators or lower-level registers, and judging whether the registers transmit data to higher-level registers;
the ranking data means comprising the following steps:
an initializing step, in which a register group is cleared, and flag bits of a control circuit are set to be 0;
a comparing step, in which data are input into each of comparators of a comparator group, the comparators compare input data in parallelism, and output the data of larger or smaller value to the corresponding registers;
a registering step, in which the register group stores K pieces of temporarily ranked maximum or minimum data in a data ranking process, wherein K is a positive integer; and
a controlling step, in which the control circuit modify the flag bits according to data transmission and comparison conditions, judge whether the registers receive data transmitted from the corresponding comparators or lower-level registers, and judge whether the registers transmit data to higher-level registers according to the flag bits.

18. The ranking data means by using the data processing chip according to claim 17, wherein in the controlling step, if an output value of one comparator is the same as the currently stored value of the corresponding register, the comparison flag bit is remained to be 0, otherwise, the comparison flag bit is set to be 1.

19. The ranking data means by using the data processing chip according to claim 17, wherein in the controlling step, when a lower-level register connected to a register transmits data to the register, the transmission flag bit is 1, otherwise, the transmission flag bit is remained to be 0.

20. The ranking data means by using the data processing chip according to claim 17, wherein in the controlling step, as for one register, except the lowest level register and the highest level register, when a comparison result returned from the corresponding comparator is received, a comparison flag bit and a transmission flag bit returned from the control circuit are also received, and if the comparison flag bit is 0, i.e., the data currently stored in the register is the same as the comparison result, no operation is performed; if the comparison flag bit is 1, the data currently stored in the register is greater or less than the newly transmitted data, and the transmission flag bit is further judged, if the transmission flag bit is 1, i.e., no data is transmitted into the register, the data currently stored in the register is transmitted to the higher-level register, data transmitted from the lower-level register is received, the transmission flag bit is returned to 0, a transmission flag bit of the higher-level register is set to be 0, and data returned from the comparator is stored.
